(19) United States
(12) Patent Application Publication
(10) Pub. No.: US 2009/0148174 A1
(43) Pub. Date: Jun. 11, 2009

(54) IMAGE FORMING APPARATUS WITH FIXING UNIT CONTROLLING ROTATION SPEED OF DRIVING ROLLER

(75) Inventor: Toshiya Inomata, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/332,163

(22) Filed: Dec. 10, 2008

Related U.S. Application Data
(60) Provisional application No. 61/012,764, filed on Dec. 10, 2007.

(51) Int. Cl. G03G 21/20; G03G 15/20

(52) U.S. Cl. 399/44; 399/68

(57) ABSTRACT

According to an embodiment of the invention, an image forming apparatus comprises a fixing unit including: a pair of rollers rotating with a recording sheet holding a toner image interposed therebetween; a driving motor rotating at least one of the pair of rollers; a heater being built in at least one of the pair of rollers to heat the roller; a timer measuring a period of time after starting operation; and a rotation speed control unit controlling the driving motor so that one of the rollers rotates in a speed higher than a rotation speed under normal conditions until a predetermined time measured by the timer.

### CROSS-REFERENCE TO RELATED APPLICATION

The application is based upon and claims the benefit of priority from U.S. provisional application No. 61/012,764, filed on Dec. 10, 2007, the content of which is incorporated herein by reference.

### TECHNICAL FIELD

The invention relates to an image forming apparatus, and more particularly to an image forming apparatus having a fixing unit which controls a rotation speed of a driving roller.

### BACKGROUND

An image forming apparatus using various schemes, such as an electro-photographic scheme, an ink jet scheme, thermal transfer scheme or the like, is widely used, which uses plain papers that are not specially processed in sheet material.

The image forming apparatus, first of all, generates an electrostatic latent image, develops the electrostatic latent image by the use of toners, transfers the developed image to a recording sheet such as the plain paper directly or to another transfer medium firstly and then to the recording sheet. In order to permanently fix the image, it is necessary to perform a fixing of the transferred toner image to the recording sheet.

In order to perform the fixing, the recording sheet holding the transferred toner image may be inserted between a pressurizing roller and a fixing belt or a fixing roller in many cases. The fixing belt or the fixing roller is heated at a predetermined temperature, and comes in contact with a toner holding area (surface) of the recording sheet. On the other hand, the pressurizing roller comes in contact with a rear surface of the recording sheet and applies pressure to the recording sheet so as to perform the fixing.

The fixing of the toner image on the recording sheet is related with a temperature of the recording sheet and a processing speed. When the toner image is fixed at a predetermined speed in a predetermined temperature, a predetermined fixing is optimally made. The fixing speed depends on a rotation speed of a motor which drives the fixing roller wound with the fixing belt or the pressurizing roller.

For keeping the temperature of the recording sheet constant, the temperature of a heater in the roller (heating roller) wound with the fixing belt is controlled in order to keep the temperature of the fixing belt constant by detecting the surface temperature of the fixing belt. Further, temperature of a built-in heater is controlled in order to keep the surface temperature of the pressurizing roller constant by detecting the surface temperature thereof.

However, when the image forming apparatus is turned on, the temperature of the heating roller and the pressurizing roller is still at a low temperature similarly to the outside, and it takes much time for the built-in heater to heat these rollers. Moreover, since the pressurizing roller and the fixing roller which are driven at a constant rotation speed are expanded as the temperature thereof rises, diameters of the rollers become large, so that a peripheral surface speed of the driving roller increases. For this reason, the time for the toner-held recording sheet to pass through the fixing unit becomes short and the fixing speed increases, so that fixing conditions are changed. Further, a speed difference between the transfer roller before the fixing unit and a paper discharge roller after the fixing unit occurs to cause sheet bending, so that the sheet is rubbed against a sheet guide. Therefore, image defects occur due to excessively pulling the sheet.

In order to solve the above problems, for example, Japanese Patent Application Laid-Open No. 2008-3297 discloses a fixing device for detecting the number of rotations of a fixing roller and a temperature of a fixing belt wound around the roller, obtaining a diameter of the fixing roller corresponding to the detected temperature, and controlling the rotation of the fixing roller according to the diameter.

However, in the fixing device, since the temperature of the fixing belt is also detected and it takes much time until a rise in temperature is detected, it is hard to change the speed of the fixing belt at a proper speed to perform the fixing at a predetermined speed if the temperature is rapidly changed similarly to the case of turning on the power.

### SUMMARY

The invention is made in consideration of the above problems in the fixing unit of the image forming apparatus, and is to provide an image forming apparatus which is able to perform a fixing at a proper speed even though the temperature of the fixing unit rapidly rises similarly to the case of turning on the power.

If the rotation speed of the driving roller in the fixing unit is constant, the diameter of the driving roller is changed when the temperature is changed, so that the peripheral surface speed of the driving roller is varied. The fixing speed corresponds to the peripheral surface speed of the driving roller. If the diameter of the driving roller is small though the rotation speed thereof is constant, the peripheral surface speed of the driving roller decreases, so that the fixing speed also decreases.

Although the driving roller is heated by a built-in heater, it takes much time for the surface temperature of the driving roller to rise up to a predetermined temperature after starting operation and the diameter of the driving roller cannot be large accordingly. In the invention, the peripheral surface speed of the driving roller, that is, the fixing speed is raised by raising the rotation speed of the driving roller during a predetermined period of time after starting operation (start of heating). Therefore, the driving roller comes to be in a constant temperature and the diameter thereof becomes large, so that the fixing speed can be increased similarly to the case when the peripheral surface speed of the driving roller increases.

The change in the rotation speed of the driving roller may be performed in 2 steps or 3 steps or more. When the change in the rotation speed of the driving roller is performed in 2 steps, first, the driving roller is rotated at a first rotation speed V1 until a first time T1 after starting operation. The first rotation speed V1 is higher than a rotation speed V0 of the driving roller which is in a steady temperature. Then, after the first time T1, the driving roller is rotated at a rotation speed until a second time T2 (T2>T1) after starting operation, which is lower than the first rotation speed but higher than the rotation speed V0 in the steady temperature.

As described above, the rotation speed of the driving roller is made to be increased right after starting operation and to be decreased until the temperature is in the steady state. Therefore, it is allowed to correct that the diameter of the driving roller increases by thermal expansion of the roller and the fixing speed increases.

According to an aspect of the invention, there is provided an image forming apparatus comprising a fixing unit including: a pair of rollers being rotated with a recording sheet holding a toner image interposed therebetween; a driving motor rotating at least one of the pair of rollers; a heater being built in at least one of the pair of rollers to heat the roller; a timer measuring a period of time after starting operation; and a rotation speed control unit controlling the driving motor so that one of the rollers rotates at a speed higher than a rotation speed under normal conditions until a predetermined time measured by the timer.

### DESCRIPTION OF THE DRAWINGS

FIG. 1 is a diagram schematically illustrating a configuration of an image forming apparatus according to an embodiment of the invention.

FIG. 2 is a diagram schematically illustrating a structure of a fixing unit of the image forming apparatus shown in FIG. 1.

FIG. 3 is a diagram illustrating a configuration including an electric circuit of the fixing unit of the image forming apparatus shown in FIG. 1.

FIG. 4 is a diagram illustrating result data obtained by experimenting on a peripheral surface speed of a transfer belt after starting operation in the image forming apparatus according to the embodiment of the invention.

FIG. 5 is a graph diagram illustrating the data shown in FIG. 4.

FIG. 6 is an explanatory diagram illustrating an operation according to another embodiment of the invention in which a rotation speed of a driving roller is changed in 2 steps.

### DETAILED DESCRIPTION

Hereinafter, an image forming apparatus according to an embodiment of the invention will be described with reference to the drawings.

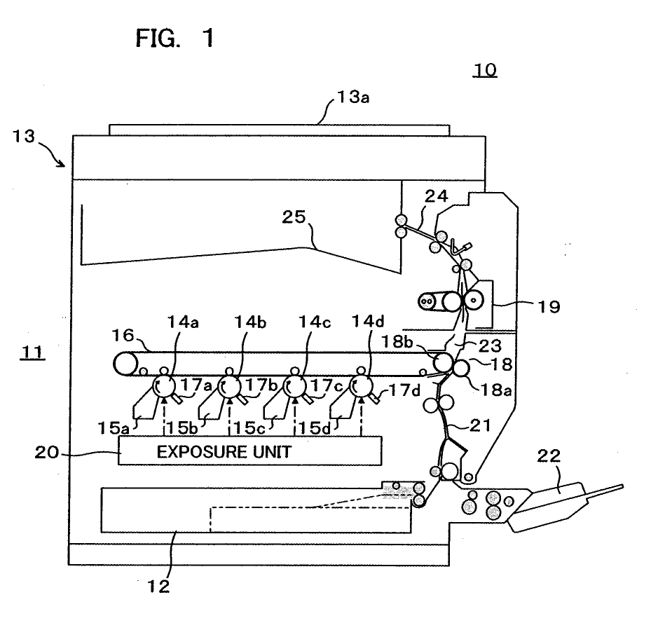

FIG. 1 shows a diagram schematically illustrating a configuration of an image forming apparatus (MFP, Multi-Functional Peripheral) to which the invention is applicable.

The image forming apparatus 10 shown in FIG. 1 includes an image forming apparatus body 11, a sheet feeding unit 12, and an image acquisition unit 13. The image forming apparatus body 11 outputs image information, for example, as an output image called as hard-copy or printout. The sheet feeding unit 12 can supply a recording sheet of an arbitrary size used in the image output with respect to the image forming apparatus body 11. The image acquisition unit 13 acquires the image information, which is subjected to image formation in the image forming apparatus body 11, as image data from an object (document) holding the image information.

The image acquisition unit 13 includes a document table (document glass) 13a supporting the object and an image sensor, for example, a CCD sensor, converting the image information into the image data. An illumination device (not shown) radiates illumination light to the document set on the document table 13a, and the image acquisition unit 13 converts the light reflected from the document into an image signal by the CCD sensor.

An instruction input unit, that is, a controller panel (operation unit) is provided at a predetermined position (not shown in FIG. 1) in the image forming apparatus 10, which instructs the image forming apparatus body 11 on a start of image formation or the image acquisition unit 13 on a start of reading the image information of the document.

The image forming apparatus body 11 includes: a first to a fourth photoconductive drums 14a to 14d holding a latent image; developing units 15a to 15d developing the latent image by supplying developers, that is, toners to the latent image held on the photoconductive drums 14a to 14d; a transfer belt 16 sequentially holding toner-images held on the photoconductive drums 14a to 14d; cleaners 17a to 17d removing toners remaining on the photoconductive drums 14a to 14d from the photoconductive drums 14a to 14d, respectively; a transfer unit 18 transferring the toner image held on the transfer belt 16 to a sheet-shaped recording medium, such as a plain paper or an OHP sheet formed of a transparent resin sheet; a fixing unit 19 fixing the toner image transferred to the recording medium by the transfer unit 18 to the recording medium; and an exposure unit 20 forming the latent image on the photoconductive drums 14a to 14d.

The image signals obtained from the image acquisition unit 13 are sent to the exposure unit 20. The photoconductive drums 14a to 14d rotate in arrow directions, respectively, and the surfaces thereof are uniformly charged in a charging unit (not shown) before being exposed by the exposure unit 20. Light images corresponding to Y (yellow), M (magenta), C (cyan) and Bk (black) are radiated to the photoconductive drums 14a to 14d, so that the latent images corresponding to the Y, M, C and Bk are formed.

The first to fourth developing units 15a to 15d contain an arbitrary color of toners of Y (yellow), M (magenta), C (cyan) and Bk (black) used for obtaining a color image and develop the latent images held on each of the photoconductive drums 14a to 14d by the use of a toner with one of colors in Y, M, C and Bk, that is, the latent images is made to be visible. The order of colors is determined by a predetermined order according to an image forming process or a toner property. The toner images formed on the photoconductive drums 14a to 14d are transferred primarily to the transfer belt 16 by fitting phases.

The transfer belt 16 holds the toner images of colors formed by the developing units 15a to 15d in the order of the formed toner images. Therefore, a color toner image is formed on the transfer belt 16.

The transfer unit 18 includes a secondary transfer roller 18a and a secondary transfer backup roller 18b, and the color toner image is supplied between both of these two rollers by the rotation of the transfer belt 16.

On the other hand, the sheet feeding unit (sheet cassette) 12 supplies a recording medium P to the transfer unit 18. The recording medium P supplied to the transfer unit 18 is also supplied between the secondary transfer roller 18a and the secondary transfer backup roller 18b and the color toner image on the transfer belt 16 is secondly transferred to the recording medium P.

In FIG. 1, although the sheet feeding unit 12 is illustrated just one, in general, there are plural sheet cassettes, in which various sizes and types of the recording mediums are contained in the plural sheet cassettes. The recording medium is withdrawn from a sheet cassette selected among the plural sheet cassettes. Alternatively, the recording medium inserted from a manual mechanism 22 is supplied to the transfer unit 18 through a medium path 21. The size of the recording medium corresponds to the size of the color toner image which is formed by the image forming apparatus body 11.

In the transfer unit 18, the color toner image on the transfer belt 16 is secondly transferred to the recording medium P which is sent through the medium path 21, and the recording medium P is sent to the fixing unit 19 through a medium path 23. The fixing unit 19 will be described in detail later. The recording medium P on which the toner image is fixed by the fixing unit 19 is loaded on a stock unit 25 located at a space between the image acquisition unit 13 and the image forming apparatus body 11 through a medium path 24.

The fixing unit 19 has a function of fixing the color toner image on the recording medium P. The perspective view illustrating the structure of the fixing unit 19 is shown in FIG. 2. The fixing unit 19 includes a heating roller 31 heated, a fixing roller 32 for fixing the toner image, an endless fixing belt 33 wound around the fixing roller 32 and the heating roller 31, and a pressurizing driving roller 34 press-contacted with the fixing belt 33 by a spring (not shown). The recording medium P of which a surface having the toner image is faced to the fixing belt 33 is made to be passed between the pressurizing driving roller 34 and the fixing belt 33 from the bottom to the top.

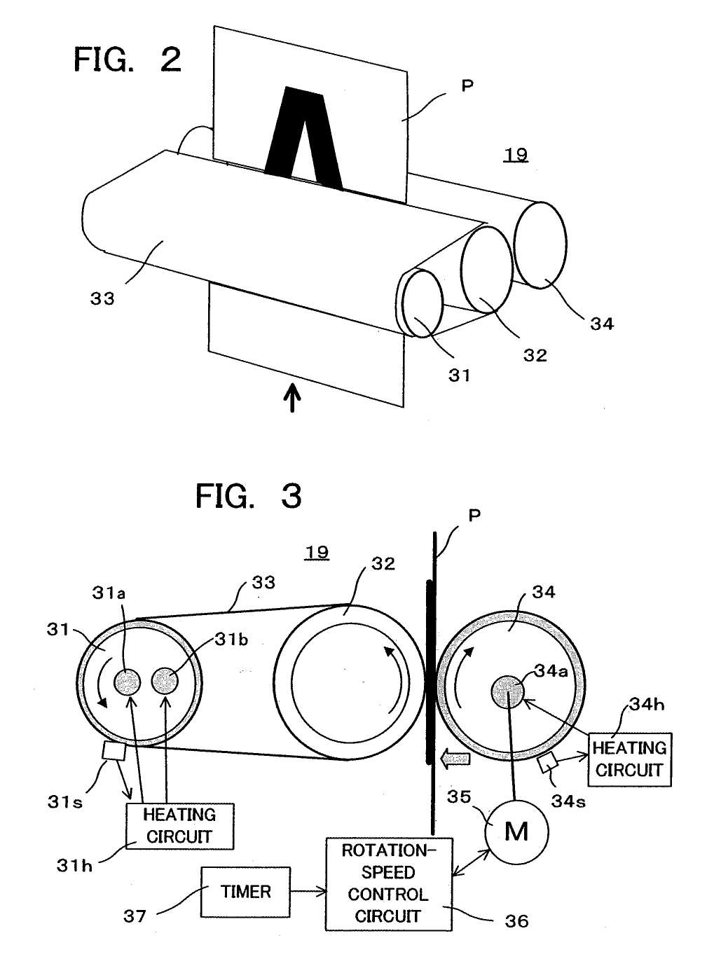

FIG. 3 shows a structure of each roller of the fixing unit 19 and a connection relationship between these rollers and electric circuits thereof. The heating roller 31 has a metal layer on the surface thereof. The fixing roller 32 has a sponge layer with a predetermined thickness on the surface thereof, and a metal core is located therein. The pressurizing driving roller 34 has a rubber layer with a predetermined thickness on the surface thereof, and a metal core is located therein.

The heating roller 31 is made of a metal pipe with a 1 mm thickness, the surface thereof is coated in order to prevent rust and improve a lubricating property. The heating roller 31 has a temperature detector 31s on the outer periphery thereof, and a temperature measured by the temperature detector 31s is input to an external heating circuit 31h. The heating circuit 31h controls heaters 31a and 31b located in the heating roller 31. The pressurizing driving roller 34 also has a temperature detector 34s on the outer peripheral thereof, and a temperature measured by the temperature detector 34s is input to an external heating circuit 34h. The heating circuit 34h controls a heater 34a located in the pressurizing driving roller 34. The heaters 31a, 31b, and 34a are configured with, for example, halogen lamps.

The heating roller 31 being heated by the heaters 31a and 31b heats the fixing belt 33 and comes to heat the surface holding the color toner image on the recording medium P, where the surface of the recording medium P is press-contacted with the fixing belt 33 when passing between the fixing belt 33 and the pressurizing driving roller 34. At this time, the pressurizing driving roller 34 heats the surface of the pressurizing driving roller 34 and comes to heat the recording medium P from the rear surface thereof. The surface temperature of the pressurizing driving roller is kept, for example, at 120° C.

The pressurizing driving roller 34 is connected to a driving motor 35 via a gear, and is rotatably driven by the driving motor 35. A rotation-speed control circuit 36 controls a rotation speed of the driving motor 35. The driving motor 35 is a kind of pulse motor whose rotation is controlled by pulses input thereto.

The rotation-speed control circuit 36 is connected to a timer 37. The timer 37 measures a period of time lapsed after starting operation, that is, a warming-up (WU) time when the image forming apparatus 10 starts, and inputs the lapsed time to the rotation-speed control circuit 36.

The rotation-speed control circuit 36 has a table as a memory (not shown), through which the rotation speed of the pressurizing driving roller 34 is changed according to a period of time after starting operation. Specifically, the rotation-speed control circuit 36 includes a speed control memory which has a correspondence relationship of the number of pulses per every minute to be supplied to the driving motor with respect to the time lapsed after the WU time. In a normal fixing in a steady temperature, the pressurizing driving motor is rotated at a rotation speed when 128 pulses per one minute are input to the driving motor 35.

Based on the number of pulses (in this case, 128 pulses) per one minute in the general case, the number of adding pulses according to a period of time after the WU time may be stored in the speed control memory as a table.

Results experimented on the image forming apparatus having the above structure will be described. The peripheral surface speed of the fixing belt 33 after starting operation (WU time) is measured with respect to an image forming apparatus capable of outputting 35 sheets per one minute and an image forming apparatus capable of outputting 45 sheets per one minute, respectively.

The heating roller 31 has a metal layer with a 1 mm thickness on the surface thereof. The fixing roller 32 has a sponge layer with an 8 mm thickness and hardness 350 in ASKER-C on the surface thereof, and a metal core is located therein. The pressurizing driving roller 34 has an outer diameter of 38 mm, a rubber layer (hardness 720 in ASKER-C) with a predetermined thickness from the surface thereof, and a metal core therein.

The rubber thickness on the surface of the pressurizing driving roller 34 is 2 mm in the case of the 35-sheet machine, and 4 mm in the case of the 45-sheet machine.

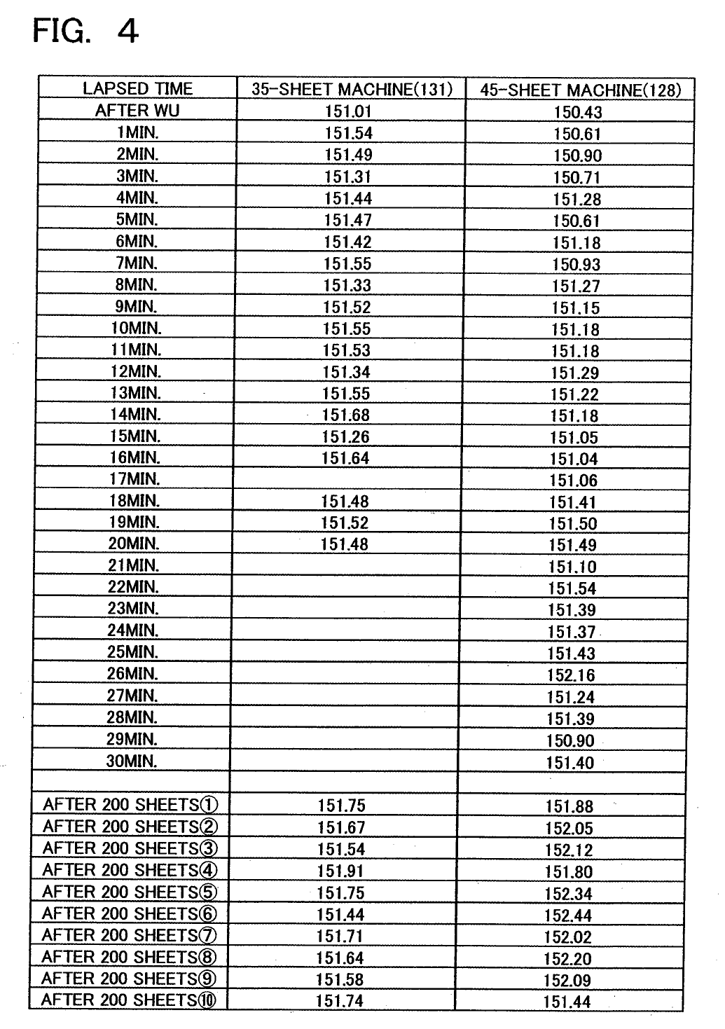

In FIG. 4, the measurement results of the speed in these two kinds of image forming apparatus are shown every one minute after starting operation. In the 45-sheet machine, a pulse signal of 128 bits/sec corresponding to a normal speed is input to the driving motor 35 from the rotation-speed control circuit 36. In the 35-sheet machine, a signal of 131 bits which is larger than 128 bits by 3 bits is supplied to the driving motor 35 for one minute.

When the number of pulses is increased by 10 bits, the rotation speed of the pressurizing driving roller rises 0.6%. Since 131 bits−128 bits=3 bits, the fixing speed in the 35-sheet machine rises about 0.18% higher than that in the 45-sheet machine.

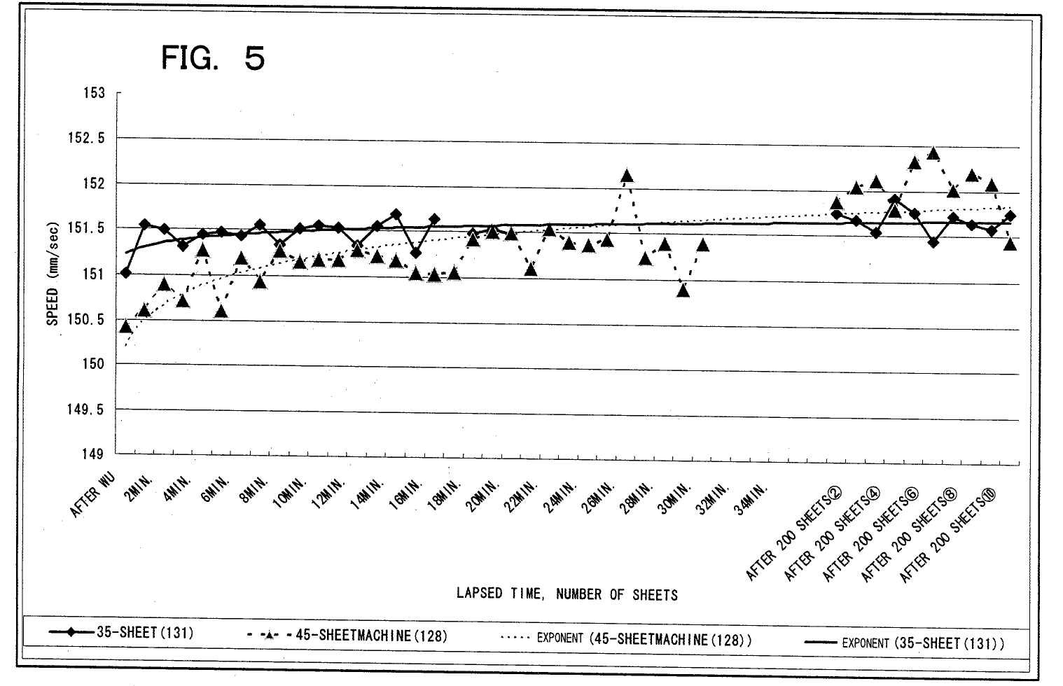

FIG. 5 shows a graph diagram illustrating the speed data of the 35-sheet machine and the speed data of the 45-sheet machine. The horizontal axis indicates a time lapsed after starting operation, and the vertical axis indicates a peripheral surface speed of the transfer belt, this is, a moving speed (mm/sec) of the recording sheet in fixing.

In FIG. 5, (♦) indicates data of the fixing speed of the 35-sheet machine, and the solid line indicates an approximated exponential curve of these data. In FIG. 5, (▴) indicates data of the fixing speed of the 45-sheet machine, and the dotted line indicates an approximated exponential curve of these data.

In the 35-sheet machine, the speed when starting operation is 151 mm/sec and changed to about 151.5 mm/sec, and then to about 151.6 mm/sec. It is understood that, in the 45-sheet machine, the speed when starting operation is 150.4 mm/sec and changed to about 152 mm/sec.

From this measurement results, it is possible to understand that, as coming near to the operation start time, the peripheral surface speed of the pressurizing driving roller becomes considerably low.

In addition, the thickness of the rubber provided on the surface of the pressurizing driving roller 34 is 2 mm in the case of the 35-sheet machine, and 4 mm in the case of the 45-sheet machine. The reason why the thickness of the rubber of the 45-sheet machine, which is a high-speed machine, is larger than that of the 35-sheet machine is to increase the contact area (nip width) between the rollers. In the 35-sheet machine, the nip width is 8 mm, and is about 9.5 mm in the 45-sheet machine. In this way, when the nip width of the pressurizing driving roller 34 is made to be increased for speed-up (for example, from 2 mm to 4 mm), the speed variation becomes large due to the thermal expansion. Therefore, it is necessary to correct the speed.

In normal room temperature (about 20° C.), the pressurizing driving roller 34 has a roller diameter of 38 mm in both the 35-sheet machine and the 45-sheet machine, and the peripheral surface speed thereof is 150 mm/sec in both in the normal room temperature.

From FIG. 5, it can be seen that the peripheral surface speed of the fixing belt when starting operation is decreased as the thickness of the rubber on the surface of the pressurizing driving roller 34 increases. That is, it can be understood that the large expansion rate and the high temperature cause the diameter of the pressurizing driving roller 34 to vary largely. Further, it can be understood that, if the thickness of the rubber is large, it is difficult to transfer the heat, and it takes much time for the heater 34a located in the pressurizing driving roller 34 to heat the surface of the roller.

From the experimental results, for example, in the 35-sheet machine, it can be understood that the rotation speed is preferably raised about 0.3% for 10 minutes after starting operation.

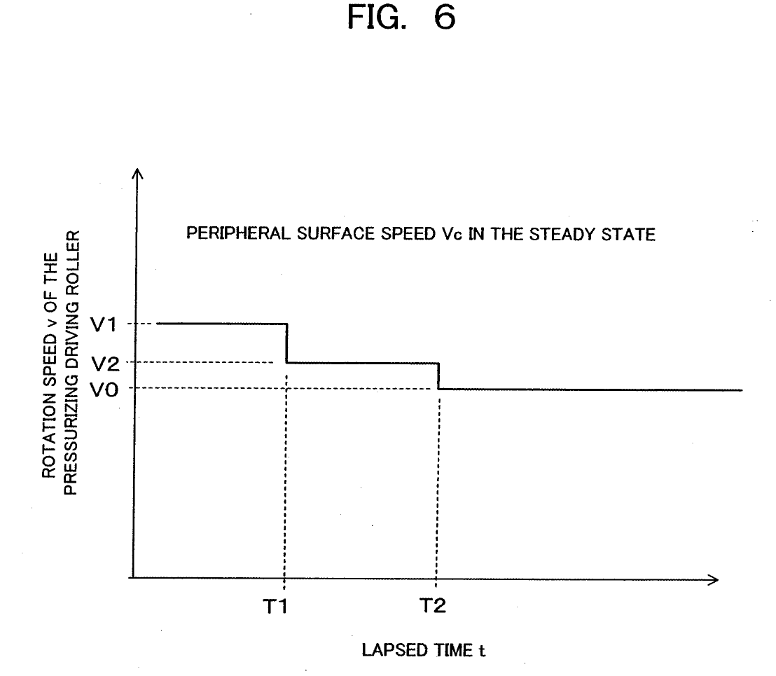

Next, in the fixing unit 19 shown in FIG. 3, another embodiment in which the rotation speed of the pressurizing driving roller 34 is changed in 2 steps will be described with reference to FIG. 6.

In this case, it is assumed that the rotation speed of the pressurizing driving roller 34 is constant. When the temperature is in a desired constant steady state passing enough time after starting operation, the actual diameter of the pressurizing driving roller 34 comes to be in a predetermined size. At this time, the peripheral surface speed of the pressurizing driving roller 34 is set to Vc, and the rotation speed thereof is set to V0.

When the pressurizing driving roller is made to be rotated at the rotation speed V0 even though the temperature when starting operation is low, the actual diameter of the roller is small because the temperature is low. Therefore, the peripheral surface speed of the pressurizing driving roller 34 is lower than the peripheral surface speed Vc. In this case, the rotation speed of the pressurizing driving roller rises up to, for example, V1 (V1>V0) by a first predetermined time T1 after starting operation even though the temperature is low, in order that the peripheral surface speed of the pressurizing driving roller 34 becomes Vc.

Next, the temperature of the pressurizing driving roller 34 increases, but if the temperature does not yet reach to the steady temperature, the peripheral surface speed does not reach to Vc. At this time, during a period of time from starting operation to the secondary time T2 after being lapsed from the first time T1, the rotation speed V2 of the pressurizing driving roller 34 is controlled to be lower than the rotation speed V1 but higher than the rotation speed V0, that is, V1>V2>V0, so that the peripheral surface speed almost equals to Vc.

Specifically, the first predetermined time T1 is 2 minutes, and the second predetermined time T2 is 15 minutes. The peripheral surface speed V1 is a speed more increased than normal by 0.8%, that is, corresponds to 128+13=141 bits. The peripheral surface speed V2 is a speed more increased than normal by 0.4%, that is, corresponds to 128+7=135 bits.

Such being this case, if the rotation speed of the pressurizing driving roller is controlled in 2 steps, the peripheral surface speed of the pressurizing driving roller due to the small roller diameter is corrected and kept almost constant. Moreover, it is possible to keep the fixing speed almost constant.

As the embodiment, if the rotation speed of the pressurizing driving roller is controlled by being separated in 2 steps, the change in the fixing speed can be suppressed more than in the case of controlling in 1 step of the above embodiment.

In the above-mentioned embodiment, the rubber is provided on the surface of the pressurizing driving roller. However, in the invention, it is possible to use a sponge instead of the rubber on the surface of the pressurizing driving roller. Further, the rubber or the sponge can be also provided on the surface of the fixing roller. Moreover, in the invention, mini-cell rollers can be adopted as these rollers.

In the above-mentioned embodiment, it is described about the fixing after the toner image is transferred from the transfer belt to the recording sheet. However, the invention is applicable to the fixing after the toner image is transferred from the transfer roller to the recording sheet.

In the above-mentioned embodiment, it is described about the fixing of the color toner image. However, the invention is applicable to the fixing of a monochrome toner image as well as the color toner image.

In the above-mentioned embodiment, it is described about that the pressurizing driving roller comes in contact with the rear surface of the recording sheet, that is, that the rotation is driven by the pressurizing roller. However, the invention is also applicable to that the fixing roller which rotatably moves the fixing belt is rotatably driven.

In the above-mentioned embodiment, it is described about the fixing using the fixing belt. However, the invention is not limited thereto, and is also applicable to that the fixing roller is directly provided opposite to the pressurizing roller and the recording sheet holding the toner image is moved by being interposed between these rollers without using the fixing roller. In this case, the roller which is driven rotatably may be the pressurizing roller or the fixing roller.

In the above-mentioned embodiment, it is described about that the driving motor is a pulse motor and the rotation thereof is changed by varying the number of pulses input to the pulse motor, so that the rotation of the roller driven by the driving motor is changed. However, in the invention, the change in the rotation of the roller may be made without using the pulse motor.

Obviously, many, modifications and variations of this invention are possible in the light of the above teachings. It is therefore to be understood that within the scope of the appended claims, this invention may be practiced otherwise than as specification.

What is claimed is:

1. An image forming apparatus comprising a fixing unit including:
a pair of rollers rotating with a recording sheet holding a toner image interposed therebetween;
a driving motor rotating at least one of the pair of rollers;
a heater being built in at least one of the pair of rollers to heat the roller;
a timer measuring a period of time after starting operation; and
a rotation speed control unit controlling the driving motor so that one of the rollers rotates at a speed higher than a rotation speed under normal conditions until a predetermined time measured by the timer.

2. The apparatus as claimed in claim 1, wherein the rotation speed control unit includes a memory storing a speed of the roller rotated at the high speed as a table with respect to a time lapsed after starting operation.

3. The apparatus as claimed in claim 2, wherein the pair of rollers corresponds to a fixing roller which comes in contact with a surface holding the toner image on the recording sheet and a pressurizing roller press-contacted with a rear surface of the recording sheet, and
wherein the roller driven by the driving motor corresponds to the pressurizing roller.

4. The apparatus as claimed in claim 3, wherein the pressurizing roller includes a pressurizing roller heater built therein to heat the pressurizing roller.

5. The apparatus as claimed in claim 4, wherein the pressurizing roller includes a rubber or sponge layer on the surface thereof.

6. The apparatus as claimed in claim 5, further comprising:
a temperature detection unit detecting a surface temperature of the pressurizing roller; and
a temperature control unit controlling a temperature of the pressurizing roller heater by a temperature detected by the temperature detection unit in order to keep the surface temperature of the pressurizing roller constant.

7. The apparatus as claimed in claim 6, wherein the predetermined time corresponds to about 10 minutes after starting operation.

8. An image forming apparatus comprising:
a developing unit developing a latent image by a toner;
a transfer unit transferring a toner image developed by the developing unit to a recording sheet; and
a fixing unit fixing the toner image, which is transferred by the transfer unit to the recording sheet, on the recording sheet,
wherein the fixing unit includes:
a heating roller being heated to a predetermined temperature by a heating roller heater built therein;
a fixing roller fixing the toner image to the recording sheet;
a fixing belt wound around the fixing roller and the heating roller;
a pressurizing roller press-contacted with the fixing roller via the fixing belt;
a timer measuring a period of time after starting operation; and
a speed control unit raising a rotation speed of the pressurizing roller or the fixing roller which is driven rotatably up to a speed higher than a speed in fixing in a steady state until the timer detects that a predetermined time is lapsed.

9. The apparatus as claimed in claim 1, wherein the rotation speed control unit includes a memory storing a speed of the pressurizing roller or the fixing roller rotated at the higher speed with respect to a time lapsed after starting operation as a table.

10. The apparatus as claimed in claim 9, wherein the pressurizing roller includes a pressurizing roller heater built therein to heating the pressurizing roller.

11. The apparatus as claimed in claim 10, wherein the pressurizing roller includes a rubber or sponge layer on a surface thereof.

12. The apparatus as claimed in claim 11, further comprising:
a pressurizing roller temperature detection unit detecting a surface temperature of the pressurizing roller;
a pressurizing roller temperature control unit controlling a temperature of the pressurizing roller heater by a temperature detected by the pressurizing roller temperature detection unit in order to keep the surface temperature of the pressurizing roller constant;
a fixing belt temperature detection unit detecting a surface temperature of the fixing belt; and
a fixing belt temperature control unit controlling a temperature of the pressurizing roller heater in order to keep the surface temperature of the fixing belt constant.

13. The apparatus as claimed in claim 12, wherein the predetermined time corresponds to about 10 minutes after starting operation.

14. An image forming apparatus comprising:
a developing unit developing an electrostatic latent image by a toner;
a transfer unit transferring a toner image developed by the developing unit to a recording sheet; and
a fixing unit fixing the toner image, which is transferred by the transfer unit to the recording sheet, on the recording sheet,
wherein the fixing unit includes:
a heating roller being heated to a predetermined temperature by a heating roller heater built therein;
a fixing roller fixing the toner image to the recording sheet;
a fixing belt wound around the fixing roller and the heating roller;
a pressurizing driving roller press-contacted with the fixing roller and rotatably driven via the fixing belt;
a timer measuring a period of time after starting operation; and
a rotation speed control unit raising a rotation speed of the pressurizing roller up to a first rotation speed V1 higher than a speed V0 in fixing in the steady state until the timer detects that a first predetermined time T1 is lapsed after starting operation, and lowering the rotation speed of the pressurizing roller down to a second rotation speed V2 lower than the first rotation speed V1 and higher than the speed V0 in fixing in the steady state until the timer detects that a second predetermined time T2 longer than the first predetermined time T1 after the first predetermined time T1 is lapsed.

15. The apparatus as claimed in claim 14, wherein the rotation speed control unit includes a memory which stores the first and the second rotation speeds V1 and V2 of the pressurizing driving roller as a table with respect to the first and the second predetermined times T1 and T2 after starting operation.

16. The apparatus as claimed in claim 15, wherein the pressurizing driving roller includes a pressurizing roller heater built therein to heat the pressurizing driving roller.

17. The apparatus as claimed in claim 16, wherein the pressurizing driving roller includes a rubber or sponge layer on the surface thereof.

18. The apparatus as claimed in claim 17, wherein the first predetermined time T1 corresponds to about 10 minutes after starting operation.
